(19) United States
(12) Patent Application Publication
(10) Pub. No.: US 2016/0034870 A1
(43) Pub. Date: Feb. 4, 2016

(54) METHOD AND SYSTEM FOR IMPOSITION OF COSTS ON SPAM ADVERTISED MERCHANTS

(71) Applicant: MasterCard International Incorporated, Purchase, NY (US)

(72) Inventors: Justin X. HOWE, San Francisco, CA (US); Steven Joel JONAS, Westport, CT (US)

(73) Assignee: MASTERCARD INTERNATIONAL INCORPORATED, Purchase, NY (US)

(21) Appl. No.: 14/815,199

(22) Filed: Jul. 31, 2015

Related U.S. Application Data
(60) Provisional application No. 62/032,066, filed on Aug. 1, 2014.

(51) Int. Cl. G06Q 20/14; G06Q 10/10; G06F 17/30; G06Q 20/40

(52) U.S. Cl. CPC G06Q 20/14; G06Q 20/405; G06Q 10/107; G06F 17/30876

(57) ABSTRACT

A method for imposing fees on a merchant includes: storing, in a merchant database, a plurality of merchant profiles, wherein each merchant profile includes data related to a merchant in violation of a rule or regulation including at least a merchant identifier; receiving, by a receiving device, an authorization request for a payment transaction, wherein the authorization request includes at least a specific merchant identifier associated with a merchant involved in the payment transaction and a transaction amount; identifying, in the merchant database, a specific merchant profile where the included merchant identifier corresponds to the specific merchant identifier; processing, by a processing device, the payment transaction for the transaction amount; processing, by the processing device, a second payment transaction for the imposition of fees on the merchant involved in the payment transaction; and processing, by the processing device, a third payment transaction for revocation of the transaction amount.

### FIELD

The present disclosure relates to the imposition of fees and costs on a merchant, specifically the imposition of fees and costs and the charging back or reversal of payment for a transaction for a merchant found to be in violation of a rule or regulation, for discouraging the merchant's violative activities.

### BACKGROUND

Payment networks and other entities that process payment transactions often charge merchants, acquirers, or other entities involved in a transaction for their services. For example, a merchant may be charged one or more fees, such as an authorization fee, compliance fee, etc. for each transaction that is processed or may be charged periodically for a number or volume of transactions processed during the period. The fees may be collected by the payment network in order to satisfy expenses and to ensure that reliable service can be provided to merchants.

While many merchants that utilize a payment network's services may do so in earnest and may be providing a valuable and honest service to consumers, some merchants may be operating in violation of one or more rules or regulations, such as in violation of a commercial code or consumer protection rules or laws. These types of merchants may be identified using various systems and methods, such as the identification of merchants involved in the distribution of spam advertisements using systems and methods as described in U.S. patent application Ser. No. 14/071,775, entitled “Method and System for Automated Detection of CAN-SPAM Violations by Merchants and Acquirers,” by Justin Xavier Howe, filed on Nov. 5, 2013 (hereinafter “the 775 application”), which is herein incorporated by reference in its entirety. However, while these merchants may be readily identified, a significant amount of time and resources may have to be expended before the merchant can be stopped based on the violated rules or regulations. In that time, a significant number of additional consumers may be taken advantage of by the violative merchant.

It may therefore be advantageous to make efforts to deter or prevent the merchant from continuing to receiving money from consumers while in violation of the rules or regulations. Thus, there is a need for a technical solution for the imposition of costs related to the processing of payment transactions on a merchant found to be in violation of a rule or regulation.

### SUMMARY

The present disclosure provides a description of systems and methods for imposing fees on a merchant.

A method for imposing fees on a merchant includes: storing, in a merchant database, a plurality of merchant profiles, wherein each merchant profile includes data related to a merchant in violation of a rule or regulation including at least a merchant identifier; receiving, by a receiving device, an authorization request for a payment transaction, wherein the authorization request includes at least a specific merchant identifier associated with a merchant involved in the payment transaction and a transaction amount; identifying, in the merchant database, a specific merchant profile where the included merchant identifier corresponds to the specific merchant identifier; processing, by a processing device, the payment transaction for the transaction amount; processing, by the processing device, a second payment transaction for the imposition of fees on the merchant involved in the payment transaction; and processing, by the processing device, a third payment transaction for revocation of the transaction amount.

A system for imposing fees on a merchant includes a merchant database, a receiving device, and a processing device. The merchant database is configured to store a plurality of merchant profiles, wherein each merchant profile includes data related to a merchant in violation of a rule or regulation including at least a merchant identifier. The receiving device is configured to receive an authorization request for a payment transaction, wherein the authorization request includes at least a specific merchant identifier associated with a merchant involved in the payment transaction and a transaction amount. The processing device is configured to: identify, in the merchant database, a specific merchant profile where the included merchant identifier corresponds to the specific merchant identifier; process the payment transaction for the transaction amount; process a second payment transaction for the imposition of fees on the merchant involved in the payment transaction; and process a third payment transaction for revocation of the transaction amount.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for imposing fees on a merchant in accordance with exemplary embodiments.

FIG. 2 is a block diagram illustrating the processing server of FIG. 1 for imposing fees on a merchant in accordance with exemplary embodiments.

FIG. 3 is a flow diagram illustrating a process for imposing fees on a violative merchant using the system of FIG. 1 in accordance with exemplary embodiments.

FIG. 4 is a diagram illustrating to process for imposing fees on a violative merchant using the processing server of FIG. 2 in accordance with exemplary embodiments.

FIG. 5 is a flow chart illustrating an exemplary method for imposing fees on a merchant in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

### System for Imposing Fees on a Merchant

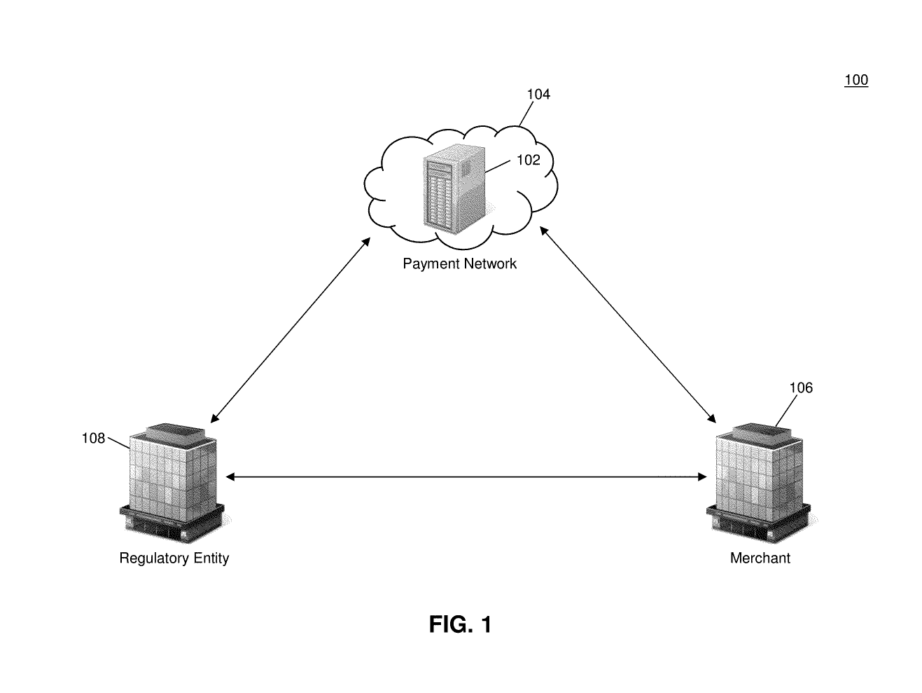

FIG. 1 illustrates a system 100 for the imposition of fees on a merchant found to be in violation of a rule or regulation.

The system 100 may include a processing server 102. The processing server 102, discussed in more detail below, may be configured to impose costs and prevent revenue and profits to a merchant 106 found to be in violation of a rule or regulation. The processing server 102 may be part of a payment network 104 configured to process payment transactions. The payment network 104 may receive an authorization request for a payment transaction involving a violative merchant 106, which may be routed to the processing server 102 for processing. The processing server 102 may then process the payment transaction and may process one or more additional transactions for fees and costs to be paid by the merchant 106.

In some embodiments, the processing server 102 may be further configured to process a third payment transaction to revoke the amount paid to the merchant in the initially processed payment transaction. The processing of the third revocation transaction may ensure that a merchant 106 in violation of a rule or regulation does not receive revenue or profits for a transaction that is associated with violative activity. The result is that the merchant 106 may be responsible for payment of authorization fees and other transaction costs, while being unable to receive profits for the transactions due to their violative activity, which may further result in the expenses for doing business for the merchant 106 being too great to continue. The merchant 106 may then be forced to stop conducting transactions with consumers entirely, thus saving consumers' money, or correct their violative activity prior to continuing to engage in commerce with consumers.

The processing server 102 may identify that a merchant 106 is in violation of a rule or regulation using methods and systems that will be apparent to persons having skill in the relevant art. For example, a merchant 106 associated with the distribution of spam advertisements may be identified using the methods and systems discussed in the 775 application, a merchant 106 that distributes counterfeit merchandise may be identified by a victimized manufacturer, or a merchant 106 in violation of a rule or regulation may be identified by a regulatory entity 108 associated with the violated rule or regulation. The regulatory entity 108 may be independent or part of the processing server 106, may be a government agency, government chartered organization, for-profit or non-profit company, or any other authority or watch group entity. The regulatory entity 108 may notify the payment network 104, and by extension the processing server 102, that the merchant 106 is in violation of a rule or regulation and that costs should be imposed and revenue revoked.

The processing server 102 may revoke revenue provided to the merchant 106 via payment reversals, refunds, chargebacks, or other processes that will be apparent to persons having skill in the relevant back. In some embodiments, the amount of the revocation may be equal to a transaction amount of the initial transaction processed by the processing server 102. In such an embodiment, the merchant 106 may accordingly receive no revenue following the processing of the revocation, but may continue to pay authorization fees and costs for the initial payment transaction.

In some instances, the processing server 102 may process the revocation transaction only in instances where the payment transaction involves a country in which the rule or regulation is violated. For example, if the merchant 106 is located in a country where there is no applicable rule or regulation that is violated, but the transaction also involves a second party (e.g., a consumer, the processing server 102, the regulatory entity 108, etc.) that is located in a country where the rule or regulation is applicable and is violated, then the revocation may be processed. In another example, if the second party involved in the transaction is located in the same country as the merchant 106 where no rule or regulation is violated, the initial transaction may be processed as normal without a revocation.

In some embodiments, the initial payment transaction may be a test transaction. For instance, the regulatory entity 108 may attempt to identify a merchant 106 that is believed to be in violation of a rule or regulation. As part of a process to identify the merchant 106, the regulatory entity 108 may enter into a transaction with the merchant 106, such as to receive identifying information for the merchant 106 via authorization request and clearing record details. The regulatory entity 108 may notify the processing server 102 of the test transaction, and the processing server 102 may process the revocation transaction after the test transaction in order to prevent the merchant 106 from receiving revenue for the test transaction. In some embodiments, the revocation may undergo a waiting period before being processed, such that the test transaction apparatus and identity of the test transaction submitter cannot be reverse engineered immediately.

In some instances, the processing server 102 may process payment transactions without the involvement of an issuing financial institution. For example, the processing server 102 may approve a payment transaction involving a violative merchant 106 without involving an issuer because the transaction amount will be revoked afterwards, or because the payment network 104 is the other entity involved in the payment transaction.

The methods and systems discussed herein for imposing fees on a merchant 106 may enable the processing server 102 to impose transaction fees and costs on a merchant 106 that is in violation of a rule or regulation while at the same time preventing the merchant 106 from receiving revenue. This can, in turn, reduce profitability for the merchant 106 that is in violation, and thereby encourage the merchant 106 to stop engaging in violative practices. As a result, merchants 106 that are in violation of a rule or regulation may stop taking advantage of consumers and other merchants quickly, such as before the regulatory entity 108 has an opportunity to take appropriate action under the violated rule or regulation.

### Processing Server

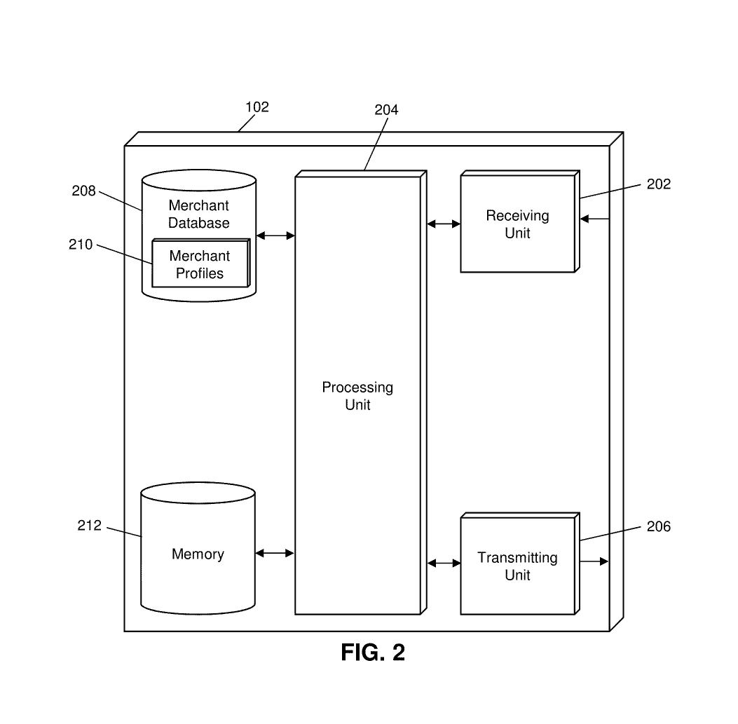

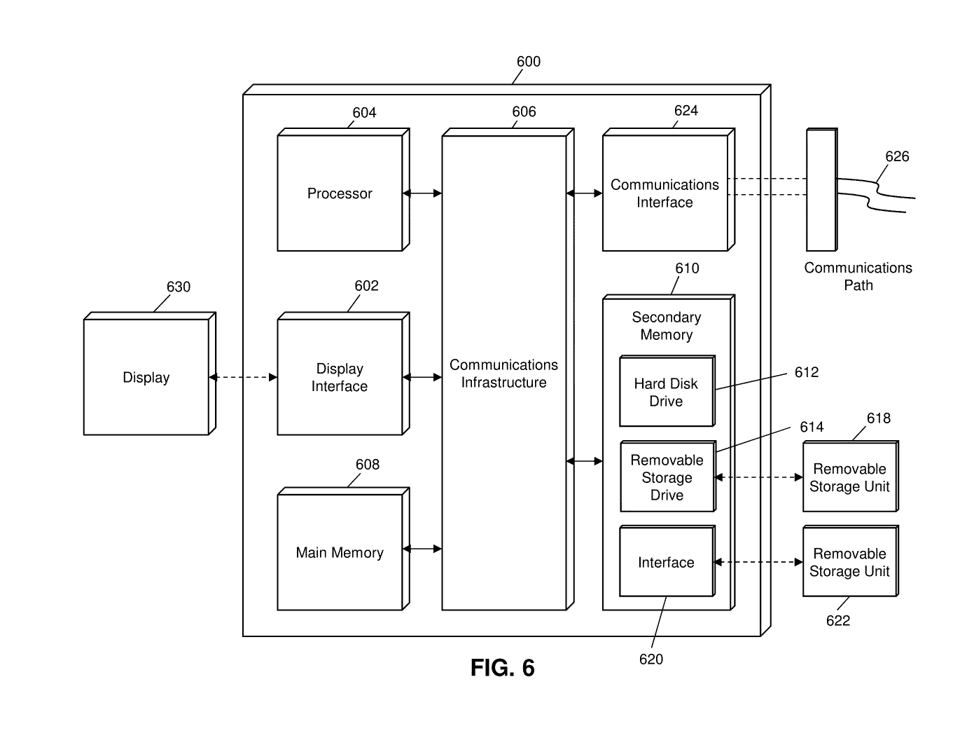

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving unit 202. The receiving unit 202 may be configured to receive data over one or more networks via one or more network protocols. For instance, the receiving unit 202 may receive authorization requests and other data associated with payment transactions via the payment network 104, and may also receive data, such as data indicating merchants being in violation of rules or regulations, from the regulatory entity 108 or other entity over one or more other networks, such as the Internet. In some embodiments, the authorization request may include an issuing country, which may be associated with an entity involved in funding the payment transaction, such as an issuing financial institution.

The processing server 102 may also include a merchant database 208. The merchant database 208 may be configured to store a plurality of merchant profiles 210. Each merchant profile 210 may include data associated with a merchant 106 that is indicated as being in violation of a rule or regulation and may include at least a merchant identifier. The merchant identifier may be a unique value associated with the respective merchant profile 210 and/or related merchant 106, such as a merchant identification number, registration number, serial number, point of sale identifier, internet protocol address, or other suitable value that will be apparent to persons having skill in the relevant art. In some embodiments, a merchant profile 210 may also include an acquiring country associated with the related merchant 106 or an acquirer associated with the related merchant 106.

The processing server 102 may further include a processing unit 204. The processing unit 204 may be configured to perform the functions of the processing server 102 disclosed herein as will be apparent to persons having skill in the relevant art. The processing unit 204 may be configured to identify a merchant profile 210 in the merchant database 208 associated with a received authorization request for an initial transaction based on a merchant identifier included in the received authorization request. The processing unit 204 may be further configured to process the initial transaction and to process a second transaction for fees to be imposed on the merchant 106 related with the identified merchant profile 210.

The processing unit 204 may also be configured to process a third transaction for the revocation of revenue to the merchant 106 resulting from the processing of the initial transaction. In some instances, the third transaction may be for a transaction amount that corresponds to a transaction amount included in the authorization request of the initial transaction. The third transaction may be a payment reversal, refund, chargeback, or other suitable type of transaction as will be apparent to persons having skill in the relevant art. In some embodiments, the third transaction may only be processed if the acquiring country and/or issuing country are located in a country in which the rule or regulation is enforced and therefore violated by the merchant 106.

The processing server 102 may also include a transmitting unit 206. The transmitting unit 206 may be configured to transmit data over one or more networks via one or more network protocols. The transmitting unit 206 may be configured to transmit an authorization response for the initial transaction based on the processing of the initial transaction by the processing unit 204. For instance, the authorization response may indicate if the initial transaction was approved or declined during processing. In some embodiments, the authorization response may be a network-authorization response that may be generated (e.g., by the processing unit 204) without involvement of an issuing financial institution (e.g., associated with the entity funding the payment transaction, such as the payment network 104 or regulatory entity 108). In some embodiments, the transmitting unit 206 may also be configured to transmit authorization responses or other transaction data to the merchant 106 corresponding to the second and third transactions.

The processing server 102 may further include a memory 212. The memory 212 may be configured to store data suitable for performing the functions of the processing server 102 disclosed herein. For example, the memory 212 may store fee or cost values or rules, algorithms for the calculation of fees or revocation amounts, communication data, and other data suitable for performing the functions disclosed herein that will be apparent to persons having skill in the relevant art.

It will be further apparent to persons having skill in the relevant art that the components of the processing server 102 illustrated in FIG. 2 and discussed herein may be further configured to perform additional functions. For example, each of the components of the processing server 102 may be configured to perform the traditional functions of a payment network 104 for processing transactions, such as the transmitting of messages to and from an issuing financial institution, the transfer of funds from one transaction account to another, the evaluation of transactions using fraud models, etc.

### Process for Imposition of Costs on a Violative Merchant

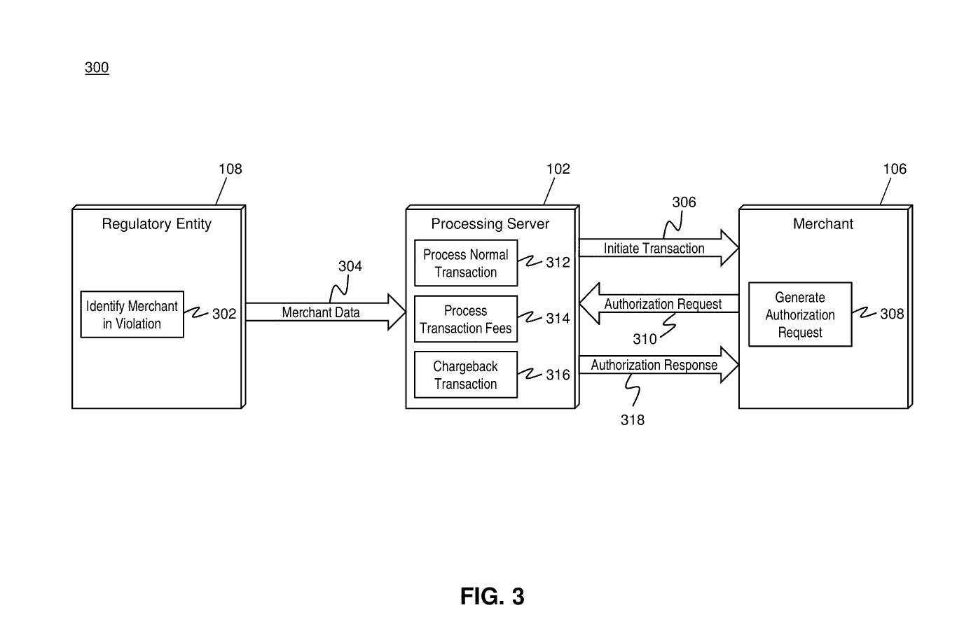

FIG. 3 illustrates a process 300 for the imposition of costs on the merchant 106 of the system 100 for the violation of a rule or regulation.

In step 302, the regulatory entity 108 may identify a merchant 106 that is in violation of a rule or regulation. For example, the regulatory entity 108 may identify that a merchant 106 is selling and distributing counterfeit merchandise. In step 304, the regulatory entity 108 may transmit merchant data associated with the merchant 106 to the processing server 102. The merchant data may include at least a merchant identifier or other identifying information associated with the merchant 106. The merchant data may be received by the receiving unit 202 of the processing server 102.

In step 306, the processing server 102 may initiate a transaction with the merchant 106 using methods and systems that will be apparent to persons having skill in the relevant art. In some embodiments, the transaction may be initiated by a different entity, such as the regulatory entity 108, a consumer, etc. In step 308, the merchant 106, or an acquirer financial institution associated with the merchant 106, may generate an authorization request for the initiated payment transaction. The authorization request may include at least a transaction amount and a merchant identifier associated with the merchant 106, such as included in the merchant data provided to the processing server 102 by the regulatory entity 108.

In step 310, the merchant 106 (e.g., or the acquirer associated with the merchant 106) may submit the authorization request to the processing server 102, which may be received by the receiving unit 202. In step 312, the processing unit 204 may process the transaction as normal using methods and systems that will be apparent to persons having skill in the relevant art. In step 314, the processing unit 204 may process a second transaction for fees to be charged to the merchant 106, such as fees associated with the processing of the first transaction, such as authorization fees, compliance fees, monitoring fees, etc.

In step 316, the processing unit 204 may process a chargeback as a third transaction. The chargeback may be for the transaction amount included in the authorization request for the initial payment transaction, or may be for the amount paid to the merchant 106 in the initial payment transaction, such as in instances where the merchant 106 may be paid an amount different from the indicated transaction amount. In step 318, an authorization response for the initial payment transaction may be transmitted by the transmitting unit 206 of the processing server 102 to the merchant 106. It will be apparent to persons having skill in the relevant art that, in some instances, step 318 may be performed prior to steps 314 and/or 316.

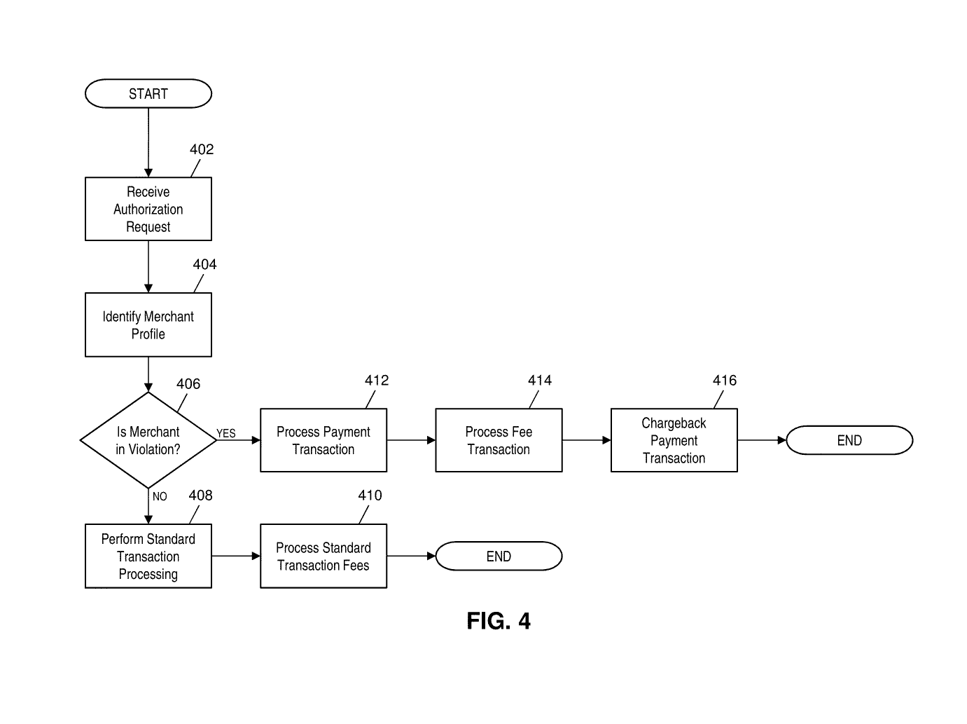

FIG. 4 illustrates a process 400 for the imposition of costs on the merchant 106 by the processing server 102.

In step 402, the receiving unit 202 of the processing server 102 may receive an authorization request for a payment transaction. The authorization request may include at least a transaction amount and a merchant identifier associated with a merchant 106 involved in the payment transaction. In step 404, the processing unit 204 of the processing server 102 may identify a merchant profile 210 stored in the merchant database 208 that includes the merchant identifier included in the received authorization request.

In step 406, the processing unit 204 may determine if the merchant 106 associated with the identified merchant database 208 and involved in the payment transaction is in violation of a rule or regulation. In some instances, any merchant 106 associated with a merchant profile 210 in the merchant database 208 may be in violation of a rule or regulation. In other instances, the merchant profile 210 may indicate if the related merchant 106 is in violation of a rule or regulation. In one embodiment, the transmitting unit 206 of the processing server 102 may transmit a request to the regulatory entity 108, which may respond with an indication of the related merchant 106 is in violation of a rule or regulation.

If it is determined that the merchant 106 involved in the payment transaction is not in violation of a rule or regulation, then, in step 408, the processing unit 204 may process the payment transaction using standard methods and systems. In step 410, the processing unit 204 may process an additional transaction for the payment of standard transaction fees by the merchant 106, such as fees associated with the processing of the initial payment transaction by the processing server 102.

If it is determined, in step 406, that the merchant 106 involved in the payment transaction is in violation of a rule or regulation, then, in step 412, the processing unit 204 may process the initial payment transaction for the transaction amount included in the authorization request. In step 414, the processing unit 204 may process a second transaction for the payment of fees by the merchant 106. In some instances, the fees charged to the merchant 106 in step 414 may be greater than the fees charged for a standard payment transaction, such as those fees charged in step 410. In step 416, the processing unit 204 may initiate a chargeback transaction against the merchant 106 for the transaction amount included in the authorization request.

### Exemplary Method for Imposing Fees on a Merchant

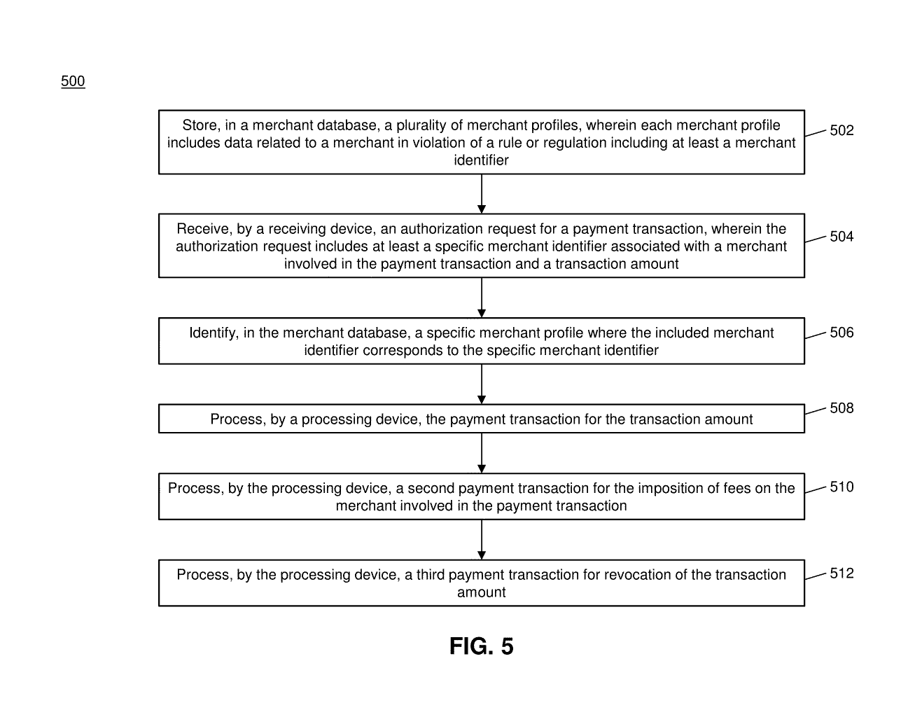

FIG. 5 illustrates a method 500 for imposing fees on a merchant identified as being in violation of a rule or regulation.

In step 502, a plurality of merchant profiles (e.g., merchant profiles 210) may be stored in a merchant database (e.g., merchant database 208), wherein each merchant profile 210 includes data related to a merchant (e.g., the merchant 106) in violation of a rule or regulation including at least a merchant identifier. In one embodiment, the rule or regulation may involve the sale of counterfeit merchandise. In another embodiment, the rule or regulation may involve the distribution of spam e-mail messages.

In step 504, an authorization request for a payment transaction may be received by a receiving device (e.g., the receiving unit 202), wherein the authorization request includes at least a specific merchant identifier associated with a merchant 106 involved in the payment transaction and a transaction amount. In step 506, a specific merchant profile 210 may be identified in the merchant database 208 where the included merchant identifier corresponds to the specific merchant identifier.

In step 508, the payment transaction may be processed for the transaction amount by a processing device (e.g., the processing unit 204). In step 510, a second payment transaction may be processed, by the processing device 204, for the imposition of fees on the merchant 106 involved in the payment transaction. In one embodiment, the fees may be associated with the processing of the payment transaction. In a further embodiment, the fees may include at least one of: authorization fees, compliance fees, and monitoring fees. In step 512, a third payment transaction may be processed, by the processing device 204, for revocation of the transaction amount. In one embodiment, the third payment transaction is at least one of: a payment reversal, chargeback, or refund.

In one embodiment, the method 500 may further include generating, by the processing device 204, the authorization request for the payment transaction. In some embodiments, the method 500 may also include transmitting, by a transmitting device (e.g., the transmitting unit 206), an authorization response in response to the received authorization request. In a further embodiment, the authorization response is a network-authorization response and is generated without involvement of an issuing financial institution. In one embodiment, each merchant profile 210 may further include an acquiring country, the received authorization request may further include an issuing country, and the third payment transaction may be processed if the acquiring country included in the specific merchant profile 210 does not correspond to the issuing country.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for imposing fees on a merchant. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for imposing fees on a merchant, comprising:
storing, in a merchant database, a plurality of merchant profiles, wherein each merchant profile includes data related to a merchant in violation of a rule or regulation including at least a merchant identifier;
receiving, by a receiving device, an authorization request for a payment transaction, wherein the authorization request includes at least a specific merchant identifier associated with a merchant involved in the payment transaction and a transaction amount;
identifying, in the merchant database, a specific merchant profile where the included merchant identifier corresponds to the specific merchant identifier;
processing, by a processing device, the payment transaction for the transaction amount;
processing, by the processing device, a second payment transaction for the imposition of fees on the merchant involved in the payment transaction; and
processing, by the processing device, a third payment transaction for revocation of the transaction amount.

2. The method of claim 1, wherein the third payment transaction is one of: a payment reversal, chargeback, or refund.

3. The method of claim 1, wherein the rule or regulation involves the sale of counterfeit merchandise.

4. The method of claim 1, wherein the rule or regulation involves the distribution of spam e-mail messages.

5. The method of claim 1, wherein the fees are associated with the processing of the payment transaction.

6. The method of claim 5, wherein the fees include at least one of:
authorization fees, compliance fees, and monitoring fees.

7. The method of claim 1, further comprising:
generating, by the processing device, the authorization request for the payment transaction.

8. The method of claim 1, further comprising:
transmitting, by a transmitting device, an authorization response in response to the received authorization request.

9. The method of claim 8, wherein the authorization response is a network-authorization response and is generated without involving an issuing financial institution.

10. The method of claim 1, wherein
each merchant profile further includes an acquiring country,
the received authorization request further includes an issuing country, and
the third payment transaction is processed if the acquiring country included in the specific merchant profile does not correspond to the issuing country.

11. A system for imposing fees on a merchant, comprising:
a merchant database configured to store a plurality of merchant profiles, wherein each merchant profile includes data related to a merchant in violation of a rule or regulation including at least a merchant identifier;
a receiving device configured to receive an authorization request for a payment transaction, wherein the authorization request includes at least a specific merchant identifier associated with a merchant involved in the payment transaction and a transaction amount; and
a processing device configured to
identify, in the merchant database, a specific merchant profile where the included merchant identifier corresponds to the specific merchant identifier,
process the payment transaction for the transaction amount,
process a second payment transaction for the imposition of fees on the merchant involved in the payment transaction, and
process a third payment transaction for revocation of the transaction amount.

12. The system of claim 11, wherein the third payment transaction is one of: a payment reversal, chargeback, or refund.

13. The system of claim 11, wherein the rule or regulation involves the sale of counterfeit merchandise.

14. The system of claim 11, wherein the rule or regulation involves the distribution of spam e-mail messages.

15. The system of claim 11, wherein the fees are associated with the processing of the payment transaction.

16. The system of claim 15, wherein the fees include at least one of: authorization fees, compliance fees, and monitoring fees.

17. The system of claim 11, wherein the processing device is further configured to generate the authorization request for the payment transaction.

18. The system of claim 11, further comprising:
a transmitting device configured to transmit an authorization response in response to the received authorization request.

19. The system of claim 18, wherein the authorization response is a network-authorization response and is generated without involving an issuing financial institution.

20. The method of claim 1, wherein
each merchant profile further includes an acquiring country,
the received authorization request further includes an issuing country, and
the third payment transaction is processed if the acquiring country included in the specific merchant profile does not correspond to the issuing country.
